(19) United States
(12) Patent Application Publication
(10) Pub. No.: US 2021/0320352 A1
(43) Pub. Date: Oct. 14, 2021

(54) METHOD AND APPARATUS

(71) Applicant: HYPERDRIVE INNOVATION LIMITED, Bunderiand Tyne and Wear (GB)

(72) Inventors: David SANDELLS, Sunderland Tyne and Wear (GB); Jason LOVELL, Sunderland Tyne and Wear (GB); Andrew WALT, Sunderland Tyne and Wear (GB)

(21) Appl. No.: 17/268,518

(22) PCT Filed: Aug. 16, 2019
(86) PCT No.: PCT/GB2019/052311

§ 371 Date: Feb. 15, 2021

(30) Foreign Application Priority Data
Aug. 16, 2018 (GB) 1813403.1

(51) Int. Cl. H01M 10/6568; H01M 50/526; H01M 10/647; H01M 50/202; H01M 10/44

(52) U.S. Cl. CPC H01M 10/6568; H01M 50/526; H01M 10/625; H01M 50/202; H01M 10/443; H01M 10/647

(57) ABSTRACT

An electrical apparatus comprising a battery for powering the apparatus, the battery comprising a plurality of elongate battery cells, the elongate battery cells each having cell bodies, and positive and negative electrical connections at a first end of the cells, and the battery cells being electrically connected together at their first ends via said connections; and, a coolant flow system arranged to cause a flow of coolant past the bodies of the battery cells toward the first ends of the battery cells.

### FIELD OF INVENTION

The present invention relates to methods and apparatus, and more particularly to batteries, battery cooling, and to battery cooling methods, which may find particular utility in apparatus comprising electric machines, such as vehicles.

### BACKGROUND

Rechargeable batteries are commonly used in many technologies, for example in electric or hybrid vehicles for use both on-highway and off-highway. For example, rechargeable batteries are frequently used in automotive applications (on highway), offshore applications (off highway), in a warehouse environment (for example for use with materials handling equipment such as fork-lift trucks and autonomous guided vehicles.

High performance batteries generate significant heat in use, and both the performance and longevity of such batteries may be adversely affected by temperature. Worse problems arise when the batteries must be charged and discharged very quickly. High electrical current generates heat.

Such high performance batteries are also vulnerable to mechanical damage. For example, if a casing of a battery cell is ruptured and/or extraneous conductive material is introduced into a cell (e.g. if a cell is punctured by a metal object) safety can be put at risk. In addition, there is a need to protect battery electrical connections to prevent electric shock and short circuit. As a result therefore, high performance battery cells are typically encapsulated in robust casings. This further exacerbates the problems of temperature control.

### SUMMARY

Aspects of the disclosure aim to address, at least in part, the above described technical problems. In particular they aim to improve cooling of batteries, and to do so in a manner that improves battery control and longevity.

Embodiments of the disclosure may do this by providing a flow of coolant first onto those parts of the battery which typically evolve less heat, before guiding that same flow of coolant over the parts of the battery in which the rate of heating is higher.

In an aspect there is provided an electrical apparatus comprising:
a battery for powering the apparatus, the battery comprising a plurality of elongate battery cells, the elongate battery cells each having cell bodies, and positive and negative electrical connections at a first end of the cells, and the battery cells being electrically connected together at their first ends via said connections; and,
a coolant flow system arranged to cause a flow of coolant past the bodies of the battery cells toward the first ends of the battery cells. This may have the effect of reducing temperature gradient across the battery. As a result, the aging and degradation of the cells may be reduced—as compared to a battery at the same average temperature, but with a greater degree of spatial variation in temperature across the battery. The effect of temperature gradient may be particularly pronounced where the battery cells are elongate
for example where they are flat shapes such as slab shapes. It may be still further pronounced when both positive and negative electrical connections to the cell are provided at the first end of the cell (e.g. disposed on the same minor surface of an elongate cell, which may be flat and slab shaped).

The coolant flow systems of the present disclosure may cause the flow of coolant to flow from a second end of the cell, opposite to the end at which the positive and negative connections are provided. As a result, the flow of coolant may flow over the bodies of the cell, cooling the body before it flows over the electrical connections.

Apparatus of the present disclosure may comprise thermal conductors, disposed at the first end for providing heat flow from the cells into the flow of coolant. These thermal conductors may have higher thermal conductivity than a skin of the cells. These thermal conductors may further conduct flow of electrical current between the cells, for example from the positive connection of one cell to the negative connection of another cell.

The battery may comprise a rigid casing encapsulating the cells. This casing may be provided by a resilient waterproof material, for example tough engineering plastic, such as glass-filled polycarbonate or nylon.

The casing may entirely enclose the battery cells, and may comprise an outflow vent for the flow of coolant fluid from the casing adjacent the first end of the cells. The cells may be arranged together in a stack wherein the casing provides a flow conduit of regular cross section across a top surface of the stack from a second end of the cells to the first end. This may promote laminar flow of coolant across the bodies of the cells thereby to increase the volume flow rate of coolant over the electrical connections, thereby improving cooling. Turbulent flow may also be present, in particular at the first end of the battery cells, e.g. at the electrical connections.

The outflow vent may be arranged to draw the flow of coolant from the flow conduit down across the electrical connections. For example, it may comprise at least one vent hole disposed on the lower half of a wall of the casing adjacent to the first end.

The casing may further comprise an inflow vent for the flow of coolant fluid into the casing adjacent a second end of the cells, opposite to the first end. The inflow vent may be arranged to provide flow of coolant up across the second ends of the cell bodies towards the flow conduit. For example, it may comprise at least one vent hole disposed on the lower half of a wall of the casing adjacent to the second end.

A temperature sensor may be disposed at the first end of one of the cells. For example it may be secured to a conductive (e.g. copper) connection to the battery at the same end of the cell as the positive and negative electrical connections. For example, one temperature sensor may be secured to each cell between the positive and negative electrical connections.

In order to monitor and control the performance of the battery, and to perform battery charge and discharge control, such as cell balancing, a battery management system (BMS) may be disposed inside the casing. The battery management system may be disposed, at least in part, at the first end of the casing adjacent the cell terminals. For example, measurement sensors such as temperature sensors may form part of the BMS, and may be disposed at the first end of the cells. In addition, the battery management system and/or other control/communication electronics of the battery may be disposed in a recess in an internal surface of the casing of the battery. Components of these electronics may be carried on a PCB, which may occlude a majority of the recess. The recess may be arranged so that coolant flowing over the battery cells is also diverted across these components in the recess (e.g. behind the PCB in the recess). The coolant may flow past these components before it reaches the first end of the battery cells. These components may comprise voltage controlled impedances and/or resistors for cell balancing (e.g. for controlling balancing and carrying dissipative currents used in balancing).

The apparatus may also be configured to control the charge and/or discharge of the cells based on signals obtained from the temperature sensor. Such function may also be performed by the battery management system.

The rate of flow of coolant may also be controlled based on signals from this sensor—for example where a fan is provided to drive the coolant the fan speed may be controlled based on the temperature.

Embodiments of the disclosure may be provided in electrical vehicles such as electric or hybrid vehicles for use both on-highway and off-highway. For example, the batteries described herein may be connected for powering an electric traction motor for moving the vehicle. Such vehicles may be for automotive applications (on highway), offshore applications (off highway), or in a warehouse environment (for example for use with materials handling equipment such as fork-lift trucks and autonomous guided vehicles. It will thus be appreciated that the battery may power auxiliary actuator systems—such as a lift or grab for manipulating and/or carrying materials in a warehouse, distribution centre or other such facility.

It will be appreciated in the context of the present disclosure that the methods and apparatus described herein may relate to batteries in which a cell module comprises a single cell, or in which each cell module comprises a number of individual cells electrically connected together in series and/or parallel. For example, some of the cell modules described herein comprise four cells arranged in two parallel strings each of two cells in series. These cells may be encapsulated together in the same casing to make up a module. The casing may be liquid tight and may be gas tight.

Any feature of any one of the examples disclosed herein may be combined with any selected features of any of the other examples described herein. For example, features of methods may be implemented in suitably configured hardware, and the configuration of the specific hardware described herein may be employed in methods implemented using other hardware.

### BRIEF DESCRIPTION OF DRAWINGS

Embodiments of the disclosure will now be described, by way of example only, with reference to the accompanying drawings, in which:

FIG. 1 shows an apparatus comprising a battery and a coolant system;

FIG. 2 shows two cross sections through a battery such as that illustrated in FIG. 1; and

FIG. 3 shows two cross sections through a vehicle comprising an apparatus such as that illustrated in FIG. 1.

In the drawings like numerals are used to indicate like elements.

### SPECIFIC DESCRIPTION

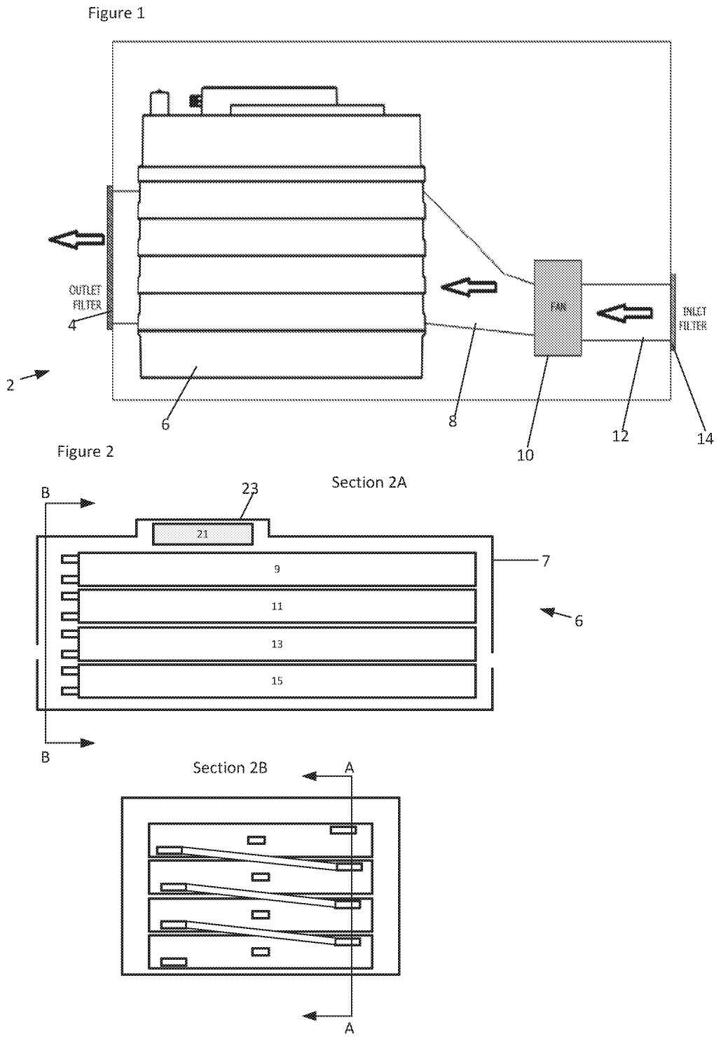

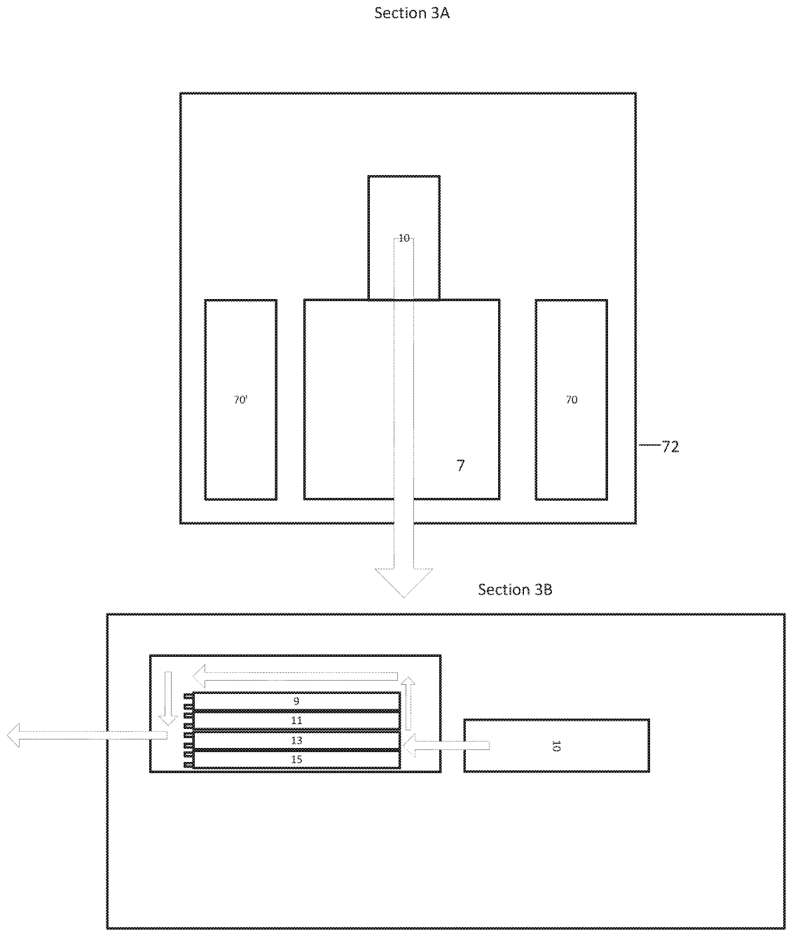

FIG. 1 is a diagram of an apparatus 2 comprising a battery 6 with a coolant flow system 4, 8, 10, 12, 14. The two section views, section 2A and section 2B, shown in FIG. 2 illustrate a battery 6 such as that shown in FIG. 1, and so the three drawings will be described together in the interests of brevity.

The first section view 2A shows a section through the battery 6 looking in the same direction as the view shown in FIG. 1. Section 2A is in the plane indicated by the line A-A in section 2B. Section 2B is in the plane indicated by the line B-B in section 2A.

As illustrated, the battery 6 may comprise a casing 7 which houses the cells 9, 11, 13, 15 of the battery 6. Although not visible in the drawings, the battery cells may comprise a skin that contains electrodes, separator, and electrolyte of the cell. The cells 9, 11, 13, 15 may be elongate, and may be flat, for example they may be slab shaped. Each cell comprises a positive electrical connection and a negative electrical connection connected to the electrodes for providing a flow of DC electrical current from the cell. As shown, each cell may also carry a temperature sensor, which may be disposed at the same end of the cell as the electrical connectors and may be disposed between the two connections—e.g. on a separate thermally conductive seat (such as a copper connector which may of be electrically connected to either of the two electrical connections of the cell).

The battery cells 9, 11, 13, 15 may be arranged in a stack, one on top of the other, with the electrical connections all at a first end of the stack. If the cells are to be connected together in series, the positive terminal of one cell is connected to the negative terminal of the next, and so on to arrange the cells in a string. Typically the links between electrical connections of adjacent cells may be provided by bus bars, which may comprise a metal such as copper.

A battery management system 21, and/or other control electronics for the battery may be provided in a recess 23 in the internal surface of the wall of the casing 6. This recess 23 may be provided in the upper wall of the casing, adjacent the top surface of the stack of batteries. This may enable coolant to flow also past these control electronics prior to flowing over the electrical connections of the battery cells at the first end of the cells. The recess 23 may also enable the cross section of the flow path over the cell to be substantially regular along at least a portion of its length. This may promote laminar flow of coolant. Turbulent flow may also be provided, for example at the first ends of the battery cells.

The coolant flow system comprises an outlet filter connected to a coolant outflow vent disposed at a first end of the casing, and an inflow filter connected to a coolant inflow vent at the second end of the casing.

The inlet filter is connected by an intake duct to an air mover, such as a fan. The fan is connected by a further duct to the air inflow vent of the casing. The casing provides at least one lumen for channelling the flow of coolant, in thermal contact with the battery cells, to the outflow vent of the casing. The outflow vent is connected by an outflow duct to the outlet filter.

The coolant flow system can be thus arranged to cause a flow of coolant past the bodies of the battery cells toward the first ends of the battery cells. This may apply the coolest coolant to the coolest parts of the battery, thereby providing a temperature difference to cause cooling. Although the coolant may have been warmed by the time it reaches the warmer parts of the battery (e.g. at the end where the electrical connections are provided) the coolant may remain cooler than these (hotter) parts of the battery thereby enabling cooling still to take place. In addition, the bus bars and/or other metallic connections into the cells at the electrical connection end may act to conduct heat efficiently out from the cells, thereby further enabling cooling. As a result, counterintuitively, coolant systems of the present disclosure may provide improved cooling by applying warmer coolant to hotter parts of the battery.

FIG. 3 shows two very schematic section views of a vehicle 72 comprising an apparatus such as that illustrated in FIG. 1. The first, section 3A, shows the vehicle 72 in plan. The second, section 3B, shows a cross section through the battery showing the cells inside the battery with the flow of coolant being channelled over them.

A coolant flow system is arranged to provide a flow of coolant through the battery so that the coolant flows across the bodies of the cells to cool them, before the flow of coolant flows from the bodies of the cells over the electrical connections. The coolant systems may thus direct coolant most strongly onto the coolest parts of the battery cells.

As illustrated in Section 3B, the cells of the battery may be arranged in a stack, one on top of the other, and the coolant flow system may be arranged to provide the coolant first against the lower part of one end of this stack of cells, opposite to the end at which the connectors are arranged. The flow of coolant is then channelled, e.g. by the battery casing, up over the stack of cells and across its top surface (perhaps also around its sides) before flowing over the end of the stack of cells at which the electrical connectors are disposed. The outlet for this flow of coolant may thus be provided towards the lower part of the casing.

It can be seen that in Section 3A that the vehicle 72 may carry the battery disposed between two actuation systems 70, 70′ of the vehicle. The actuation systems may be connected to receive electrical power from the battery and are arranged for performing mechanical operations such as manipulating objects to be carried or moved by the vehicle.

It will be appreciated from the discussion above that the embodiments shown in the Figures are merely exemplary, and include features which may be generalised, removed or replaced as described herein and as set out in the claims. For example, the inlet and outlet filters are optional. And the air mover illustrated in FIG. 1 may be provided at the outlet to draw coolant through the battery casing. This may be done in addition to, or as an alternative to, providing an air mover at the intake. The air mover may comprise a fan, a pump, or may be driven by a passive air intake (e.g. from an air intake of a moving vehicle). Typically, the coolant is air or another gas, but liquid coolant may also be used.

The casing is also optional, and the battery cells may be encapsulated by parts of the vehicle, which may act to provide a lumen to channel air over the cells.

With reference to the drawings in general, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit. The above embodiments are to be understood as illustrative examples. Further embodiments are envisaged.

For example, reference has been made to the promotion of laminar flow in parts of the coolant flow—in particular across the top of the stack of batteries. It will be appreciated in the context of the present disclosure however that turbulent flow may also be present. In addition, particular features of the construction may be configured to promote turbulent flow in one or more regions of the battery. For example, methods of the present disclosure may comprise providing a turbulent flow of coolant adjacent one or more parts of the battery cells. Such flow may be provided around one or more regions of the battery cells such as, for example, the electrical connections at the first ends of the battery.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An electrical apparatus comprising:
a battery for powering the apparatus, the battery comprising a plurality of elongate battery cells, the elongate battery cells each having cell bodies, and positive and negative electrical connections at a first end of the cells, and the battery cells being electrically connected together at their first ends via said connections; and,
a coolant flow system arranged to cause a flow of coolant past the bodies of the battery cells toward the first ends of the battery cells.

2. The apparatus of claim 1 wherein the coolant flow system causes the flow of coolant to flow from a second end of the cells, opposite to the first end.

3. The apparatus of claim 1 comprising thermal conductors, disposed at the first end for providing heat flow from the cells into the flow of coolant.

4. (canceled)

5. The apparatus of claim 1 wherein the battery comprises a casing encapsulating the cells.

6. The apparatus of claim 5 wherein the casing comprises an outflow vent for the flow of coolant fluid from the casing adjacent the first end of the cells wherein the cells are arranged together in a stack wherein the casing provides a flow conduit of regular cross section across a top surface of the stack from a second end of the cells to the first end.

7. (canceled)

8. The apparatus of claim 6 wherein the outflow vent is arranged to draw the flow of coolant from the flow conduit down across the electrical connections.

9. The apparatus of claim 5 the casing further comprising an inflow vent for the flow of coolant fluid into the casing adjacent a second end of the cells, opposite to the first end.

10. The apparatus of claim 1 comprising a temperature sensor, disposed at the first end of one of the cells.

11. The apparatus of claim 10, wherein one temperature sensor is secured to each cell between the positive and negative electrical connections.

12. The apparatus of claim 10 wherein the apparatus is configured to control at least one of:
(i) the charge and/or discharge of the cells;
(ii) the flow of coolant;
based on a temperature signal from the temperature sensor.

13. An electrical machine comprising an electrical apparatus comprising: a battery for powering the apparatus, the battery comprising a plurality of elongate battery cells, the elongate battery cells each having cell bodies having a first end and a second end, and positive and negative electrical connections, and the battery cells being electrically connected together at their first ends via said connections; and,
a coolant flow system arranged to cause a flow of coolant past the bodies of the battery cells;
wherein the electrical machine comprises actuators disposed either side of the battery, and an electrical supply connection from a first end of the battery for providing a power supply to the electrical machine.

14. A method of reducing temperature gradient across a battery in a battery cooling system of an electrical apparatus, the method comprising:
warming a flow of coolant, by passing the flow of coolant across battery cells toward a first end of the battery cells, and
passing the warmed flow of coolant across electrical connections of the cells at the first end.

15. The method of claim 14, wherein the battery cells are elongate, the elongate battery cells each having positive and negative electrical connections at the first end of the cells, and the battery cells being electrically connected together at their first ends via said connections.

16. The method of claim 14 comprising causing the flow of coolant to flow from a second end of the cells, opposite to the first end.

17. The method of claim 15 comprising providing heat flow from the cells into the thermal conductors, disposed at the first end for the flow of coolant.

18. (canceled)

19. The method of claim 14 wherein the battery comprises a casing encapsulating the cells.

20. The method of claim 19 comprising exhausting the flow of coolant fluid from the casing from an outflow vent adjacent the first end of the cells wherein the cells are arranged together in a stack, the method comprising providing a laminar flow of coolant, via a flow conduit of regular cross section across a top surface of the stack from a second end of the cells to the first end.

21. (canceled)

22. The method of claim 20 comprising drawing the flow of coolant from the flow conduit down from the top surface of the stack, and across the electrical connections.

23. The method of claim 14 comprising providing coolant into the flow of coolant fluid via an inflow vent adjacent a second end of the cells, opposite to the first end.

24. The method of claim 14 comprising obtaining a temperature signal, from a temperature sensor disposed at the first end, and controlling at least one of:
(i) the charge and/or discharge of the cells; and
(ii) the flow of coolant;
based on a temperature signal from the temperature sensor.

25. (canceled)
